(19) United States
(12) Patent Application Publication
(10) Pub. No.: US 2004/0026605 A1
(43) Pub. Date: Feb. 12, 2004

(54) Apparatus and method for turning a page in a personal information terminal

(75) Inventors: Sang-Goog Lee, Anyang-City (KR); Joon-Kee Cho, Busan (KR)

Correspondence Address: SUGHRUE MION, PLLC, 2100 PENNSYLVANIA AVENUE, N.W., WASHINGTON, DC, 20037, US

(73) Assignee: Samsung Electro-mechanics Co., Ltd.

(21) Appl. No.: 10/372,192

(22) Filed: Feb. 25, 2003

(30) Foreign Application Priority Data
Aug. 12, 2002 (KR) 2002-47517

(51) Int. Cl. G06M 7/00

(52) U.S. Cl. 250/221

(57) ABSTRACT

An apparatus for turning a page and a method for turning a page in a personal information terminal including a finger movement sensing unit which senses a trace of a user's finger movement, a characteristic extracting unit which extracts a characteristic of the trace sensed by the finger movement sensing unit, a suitability determining unit which determines a suitability of the characteristic extracted by the characteristic extracting unit for turning a page, and a page turning unit which outputs a turned page to an output device if the characteristic is determined to be suitable for turning a page as a result of the determination of the suitability determining unit. Therefore, it is possible to improve a user's convenience by making the user feel comfortable as if the user turns a page of an actual paper book.

### BACKGROUND OF THE INVENTION

1. Field of the Invention

The present invention relates to an apparatus and a method for turning a page in a personal information terminal, and more particularly, to an apparatus and a method for turning a page by a movement of a user's finger. The present application is based on Korean Patent Application No. 2002-47517 filed on Aug. 12, 2002, which is incorporated herein by reference.

2. Description of the Related Art

As computing technologies have greatly improved, there have been sharp increases in the demand for personal information terminals. In addition, e-books, which are created by adding a concept of an electronic publication to the personal information terminals, are now spreading quickly. In current e-book technology, turning pages is enabled by a physical button such as a page-up button 120 or a page-down button 130, or a software button 110 using a graphic user interface of a personal information terminal 100 as shown in FIG. 1.

Although it is possible to construct and use a system rather simply, as in this case, differences between turning pages of an actual paper book and pressing a button for turning pages of an e-book make a user feel uncomfortable, and even make a user reluctant to use the electronic medium.

### SUMMARY OF THE INVENTION

To solve the above-described and related problems, it is an object of the present invention to provide an apparatus and a method for turning a page in a personal information terminal, so as to improve a user's conveniences by enabling the user to feel comfortable, substantially in the same manner as when the user reads a paper book.

In one aspect of the present invention, there is provided an apparatus for turning a page in a personal information terminal, the apparatus comprising a finger movement sensing unit which senses a trace of a user's finger movement and a page-turning unit which executes a page-turning function in cooperation with an output device, by sensing of the finger movement sensing unit.

In another aspect of the present invention, there is provided an apparatus for turning a page in a personal information terminal, the apparatus comprising a finger movement sensing unit which senses a trace of a user's finger movement, a characteristic extracting unit which extracts a characteristic of the trace sensed by the finger movement sensing unit, a suitability determining unit which determines a suitability of the characteristic extracted by the characteristic extracting unit for turning the page, and a page turning unit which outputs a turned page to an output device if the characteristic is determined to be suitable for turning the page as a result of the determination of the suitability determining unit.

In another aspect of the present invention, there is provided an apparatus for turning a page in a personal information terminal, the apparatus comprising a first soft touch sensor and a second soft touch sensor which sense a touch of a user's finger and a page turning unit which outputs a turned page to an output device if the first soft touch sensor and the second soft touch sensor sense the touch of the user's finger, respectively, in a predetermined interval.

In yet another aspect of the present invention, there is provided an apparatus for turning a page in a personal information terminal, the apparatus comprising a user's finger movement sensing unit which includes an optical sensor sensing a user's finger movement and a page turning unit which outputs a turned page to an output device if the optical sensor senses the user's finger movement.

Preferably, the user's finger movement sensing unit includes a first optical sensor and a second optical sensor, wherein a quantity of a light received by a light receiving device is decreased by the user's finger passing between a light emitting device and the light receiving device of the first optical sensor, a quantity of a light received by a light receiving device is decreased by the user's finger passing between a light emitting device and the light receiving device of the second optical sensor, the user's finger movement is sensed by an intervals between the time when the quantity of the light received by the light receiving device of the first optical sensor is decreased and the time when the quantity of the light received by the light receiving device of the second optical sensor is decreased.

In another aspect of the present invention, there is provided a method for turning a page in a personal information terminal, the method comprising sensing a trace of a user's finger movement and turning the page in cooperation with an output device according to the sensing of the finger movement sensing unit.

In another aspect of the present invention, there is provided a method for turning a page in a personal information terminal, the method comprising sensing a trace of a user's finger movement, extracting a characteristic of the sensed trace, determining a suitability of the extracted characteristic for turning the page, and outputting a turned page on an output device if the characteristic is suitable for turning the page as a result of the determination.

In another aspect of the present invention, there is provided a method for turning a page in a personal information terminal, the method comprising sensing a touch of a user's finger by a first soft touch sensor and a second soft touch sensor and outputting a turned page to an output device if the first soft touch sensor and the second soft touch sensor sense the touch of the user's finger respectively in a predetermined interval.

In another aspect of the present invention, there is provided a method for turning a page in a personal information terminal, the method comprising sensing a user's finger movement by an optical sensor and outputting a turned page to an output device if the optical sensor senses the user's finger movement.

Preferably, the optical sensor includes a first optical sensor and a second optical sensor, and the sensing of a user's finger is characterized in that a quantity of a light received by a light receiving device is decreased by the user's finger passing between a light emitting device and the light receiving device of the first optical sensor, a quantity of a light received by a light receiving device is decreased by the user's finger passing between a light emitting device and the light receiving device of the second optical sensor, and the user's finger movement is sensed by an interval between the time when the quantity of the light received by the light receiving device of the first optical sensor is decreased and the time when the quantity of the light received by the light receiving device of the second optical sensor is decreased.

### BRIEF DESCRIPTION OF THE DRAWINGS

The above objects and advantages of the present invention will become more apparent by describing in detail preferred embodiments thereof with reference to the attached drawings in which:

FIG. 1 is a view for explaining an apparatus for turning a page according to the conventional art;

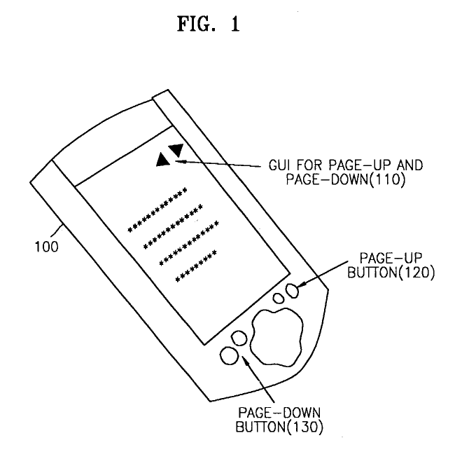

FIGS. 2A-2D are views for explaining a method for turning pages in an e-book according to the present invention;

FIG. 3 is a view of an embodiment of a structure of an apparatus for turning a page according to the present invention;

FIG. 4 is a flow chart for explaining a process of turning pages according to the present invention;

FIG. 5 is a view of an embodiment of a movement sensing unit in an apparatus for turning a page according to the present invention;

FIG. 6 is a view of another embodiment of a movement sensing unit in an apparatus for turning a page according to the present invention;

FIG. 7 is a view of still another embodiment of a movement sensing unit in an apparatus for turning a page according to the present invention;

FIG. 8 is a view of a detailed structure of the optical sensor of FIG. 7; and

FIG. 9 is a view of an example of an e-book according to the present invention.

### DETAILED DESCRIPTION OF THE INVENTION

Hereinafter, the present invention will be described in greater detail with reference to the accompanying drawings.

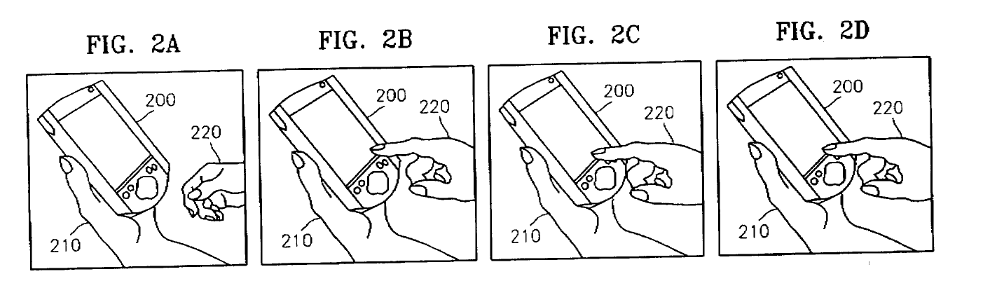

A method for turning pages according to the present invention will be described, referring to FIG. 2.

When an e-book is embodied on a personal information terminal such as a PDA (Personal Digital Assistant), a laptop computer or the like, a user holds an information terminal 200 in his/her left hand 210 as shown in FIG. 2A and turns a page using his/her right hand 220, by placing, for example, his/her index finger at a lower right side area of the information terminal as shown in FIG. 2B and moving his/her index finger from right to left as shown in FIGS. 2C and 2D, as if the user turns a page of a paper book. Then, an apparatus for turning a page according to the present invention senses a movement of the user's finger, extracts characteristics of the movement and turns a page if the characteristics are determined to be suitable for turning the page.

As described above, the user can turn pages of an e-book by performing the same operation as turning pages of a traditional paper book without any physical buttons.

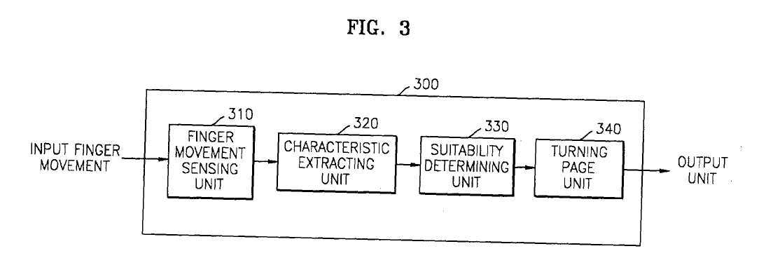

An embodiment of an apparatus for turning a page according to the present invention will be described, referring to FIG. 3.

An apparatus for turning a page 300 comprises a finger movement sensing unit 310, a characteristic extracting unit 320, a suitability determining unit 330, and a page-turning unit 340.

The finger movement sensing unit 310, which is a kind of a sensor unit for sensing a finger movement of a user intending to turn a page, obtains a trace of the finger movement from a first contact of the user's finger with the finger movement sensing unit 310. The finger movement sensing unit 310 can be installed in any part of the personal information terminal, however, it is desirable to be installed at the right corner in a low area of the personal information terminal, so as to perform nearly the same operation as turning a page of the traditional paper book. Also, it is possible to install the finger movement sensing unit 310 at the left side corner in a low area of the personal information terminal, so as to turn to a previous page. Besides, the finger movement sensing unit 310 can employ a touch screen option usually used as a character input means for recognizing a character in a personal information terminal like the PDA, or employ any other means for sensing movements.

The characteristic extracting unit 320 extracts characteristic information of the trace of the finger movement received from the finger movement sensing unit 310 based on, for example, image processing. The characteristic information consists of a length of a trace from a starting point where the finger contacts the finger movement sensing unit 310 to a rest point where the finger is located away from the finger movement sensing unit 310, a direction in which the finger moves from right to left or left to right, a continuity of the trace of the finger movements, or the like.

Next, the suitability determining unit 330 determines a suitability of the finger movements for turning pages based on the extracted characteristic information and commands the page-turning unit 340 to turn a page if the finger movements are determined to be suitable. The suitability for turning a page is determined by, for example, the length of the trace of the finger movements being longer than a predetermined critical value, the direction of the finger movements being from left to right or from right to left, and the trace of the finger movements being interrupted, or the like. If it is determined that the length of the trace of the finger movements is not larger than the predetermined critical value, the direction of the finger movements is not from left to right or from right to left, or the trace of the finger is interrupted, the suitability determining unit 330 determines the characteristic to be unsuitable for turning a page and so terminates running the apparatus for turning pages.

Afterwards, the page-turning unit 340 receives a page turning command from the suitability determining unit 330, and turns a page by outputting the next page to an output unit. Here, when the direction of the trace of the characteristics extracted by the characteristic extracting unit 320 is from left to light, a page can be turned in a direction of increasing a page number. When the direction of the trace is from right to left, a page can be turned in a direction of decreasing a page number. Further, the page-turning unit 340 not only can output a next page but can also output an animation presenting an action of turning a page or a sound of turning a page, so as to perform the function of turning a page of an e-book as close as possible to the function of turning a page of the traditional paper book.

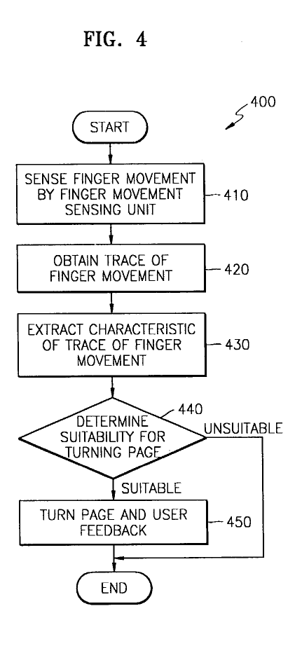

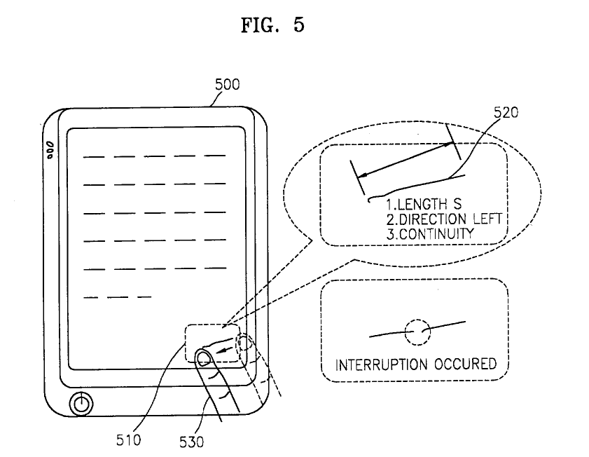

A page turning operation will be described in detail, referring to FIGS. 4 and 5.

First, the user puts his/her finger 530 on the finger movement sensing unit 310 (see FIG. 3) installed at a right lower side area 510 of the information terminal 500 and moves the finger a predetermined distance 520, and then the finger movement sensing unit 310 senses the movements of the user's finger (operation 410) and obtains a trace of the movements of the user's finger (operation 420).

Next, the characteristic extracting unit 320 (see FIG. 3) extracts the characteristics of the trace of the movements of the user's finger (operation 430), and so the suitability determining unit 330 (see FIG. 3) determines the suitability of the characteristics for turning a page by examining whether the trace of the movements of the user's finger is longer than the predetermined distance 520, which direction the trace is in, or whether the trace is interrupted, and/or the like (operation 440).

Then, if the characteristics are determined to be unsuitable for turning a page as a result of the determination of the suitability determining unit 330, running the apparatus for turning pages is terminated. If the characteristics are determined to be suitable for turning a page, the page-turning unit 340 turns a page and outputs the page to the output unit (operation 450).

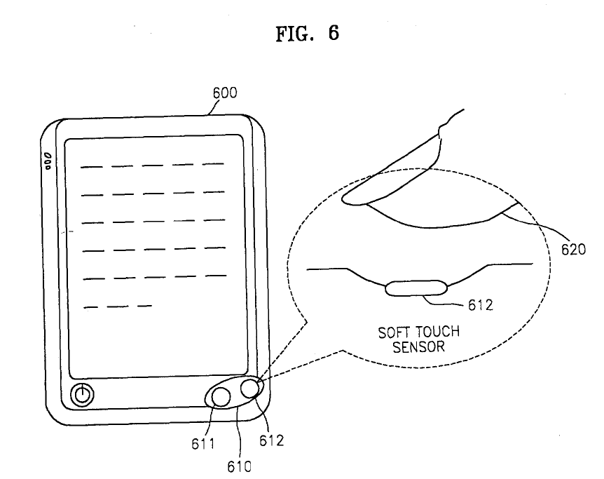

A second embodiment of the finger movement sensing unit 310 in the apparatus for turning a page according to the present invention is illustrated in FIG. 6.

In the second embodiment, a soft touch sensor is used as the finger movement sensing unit 610, which is even capable of sensing a gentle touch.

A direction of the movement of the user's finger can be checked by two soft touch sensors 611 and 612. If the user's finger moves slightly from a first soft touch sensor 612 to a second soft touch sensor 611, the first soft touch sensor 612 senses the touch of the user at first, and then the second soft touch sensor 611 senses the touch after a predetermined time, and then the suitability determining unit senses the direction to be from the right to the left after examining the direction of the movements of the user's finger and determines the suitability of turning a page, and so the page turning unit turns a page.

The characteristic extracting unit 320 is unnecessary for the page-turning apparatus that employs the soft touch sensor according to the second embodiment because it is not required to extract the characteristics of the trace of the movements of the user's finger. The page-turning apparatus according to the second embodiment can be constructed with the finger movement sensing unit 310 implemented by the soft employing the soft touch sensor, the suitability determining unit 330, and the page turning unit 340.

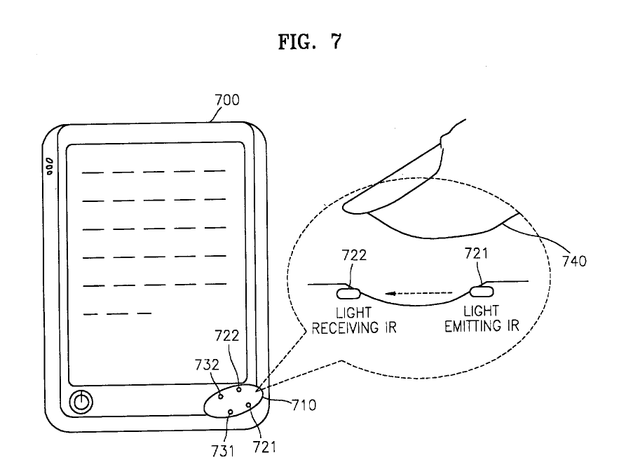

A third embodiment of the finger movement sensing unit 310 in the page-turning apparatus according to the present invention is illustrated in FIG. 7.

In the third embodiment, an optical sensor having a light receiving device and a light emitting device is used as the finger movement sensing unit 710.

A basic principle of sensing movements by using the light receiving device and the light emitting device is as follows. The light emitting device 721 and the light receiving device 722 are installed as shown in FIG. 7, in a right lower corner, and the light receiving device 722 receives an output light from the light emitting device 721. Here, the user's finger 740 passes between the light emitting device and the light receiving device, the light output from the light emitting device is blocked by the user's finger, and as a result, a quantity of the light the light receiving device receives is decreased and the movements of the user's finger can be sensed.

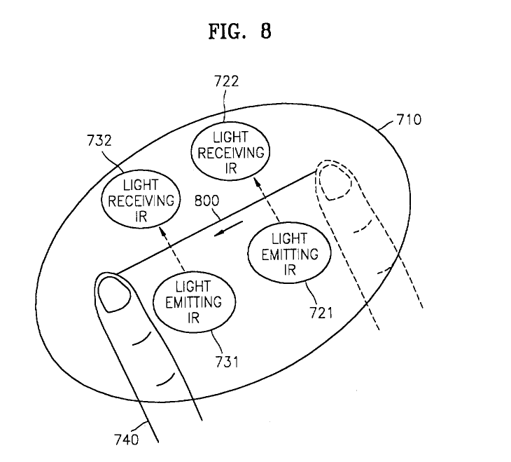

Referring to FIG. 8, the finger movement sensing unit in which the optical sensor is installed to sense the movements of the user's finger having a certain direction, which, by applying the above principle, will be described in detail as follows.

The finger movement sensing unit 710 of FIG. 8 comprises a pair of optical sensors having a light emitting device 721 and a light receiving device 722, and another pair of optical sensors having a light emitting device 731 and a light receiving device 732.

If the user's finger 740 moves from the right side to left along a trace 800, then a quantity of light the light receiving device 722 receives is decreased and a quantity of light the light emitting device 731 receives is decreased also after a predetermined time. Therefore, it is possible to sense the movements of the user's finger through a sequence of the light receiving devices having a decrease in the quantity of light.

Similar to the second embodiment, in the third embodiment, the characteristic extracting unit 320 is unnecessary for the page-turning apparatus because it is not required to extract the characteristics of the trace of the movements of the user's finger, and the page-turning apparatus can be realized by the finger movement sensing unit 310 employing the optical sensor, the suitability determining unit 330, and the page-turning unit 340.

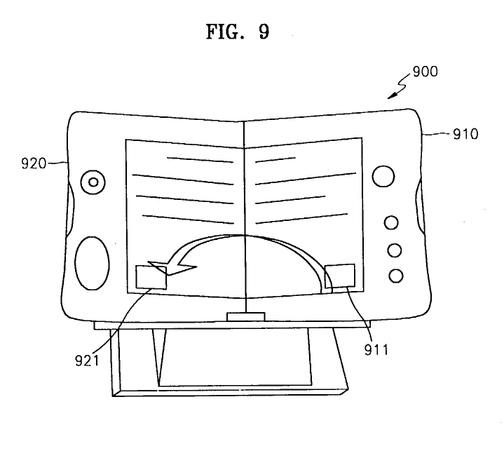

FIG. 9 illustrates a preferred example of an e-book using an apparatus for turning a page according to the present invention.

Two output devices 910 and 920 are shaped like an actual paper book. A sensing means 921 for sensing a movement of a finger from left side to right side is installed in a left lower corner of the output device 920, and a sensing means 911 for sensing a movement of a finger from right to left is installed in the right lower corner of the output device 910.

Through such a construction, a movement of turning to a next page is sensed by the sensing means 911 and a movement of turning to a previous page is sensed by the sensing means 921, thereby making the page turning of an e-book as close as possible to the page turning of an actual paper book.

As described above, the present invention improves user's convenience by making the user feel comfortable as if the user turns a page of the actual paper book.

While this invention has been particularly shown and described with reference to preferred embodiments thereof, it will be understood by those skilled in the art that various changes in form and details may be made therein without departing from the spirit and scope of the invention as defined by the appended claims and equivalents thereof.

What is claimed is:

1. An apparatus for turning a page in a personal information terminal, the apparatus comprising:
a finger movement sensing unit which senses a trace of a user's finger movement; and
a page-turning unit which executes a page-turning function in cooperation with an output device according to the sensing of the finger movement sensing unit.

2. An apparatus for turning a page in a personal information terminal, the apparatus comprising:
a finger movement sensing unit which senses a trace of a user's finger movement;
a characteristic extracting unit which extracts a characteristic of the trace sensed by the finger movement sensing unit;
a suitability determining unit which determines a suitability of the characteristic extracted by the characteristic extracting unit for turning the page; and
a page turning unit which outputs a turned page to an output device if the characteristic is determined to be suitable for turning the page based on the determination of the suitability determining unit.

3. The apparatus of claim 2, wherein the finger movement sensing unit is a touch screen.

4. The apparatus of claim 2, wherein the characteristic comprises at least one of a direction, a length, and a continuity of the trace.

5. The apparatus of claim 2, wherein the page turning unit outputs at least one of an animation and a sound presenting a page-turning motion.

6. The method of claim 2, wherein the personal information terminal comprises one of a PDA and a laptop computer.

7. An apparatus for turning a page in a personal information terminal, the apparatus comprising:
a first soft touch sensor and a second soft touch sensor, each of which sense a touch of a user's finger; and
a page turning unit which outputs a turned page to an output device if the first soft touch sensor and the second soft touch sensor sense the touch of the user's finger, respectively, in a predetermined interval.

8. An apparatus for turning a page in a personal information terminal, the apparatus comprising:
a user's finger movement sensing unit which includes an optical sensing device sensing a user's finger movement; and
a page turning unit which outputs a turned page to an output device if the optical sensor senses the user's finger movement.

9. The apparatus of claim 8, wherein the optical sensing device of said user's finger movement sensing unit comprises a first optical sensor and a second optical sensor, wherein a quantity of a light received by a light receiving device of the first optical sensor is decreased by a user's finger passing between a light emitting device of the first optical sensor and a light receiving device of the first optical sensor, wherein a quantity of a light received by a light receiving device of the second optical sensor is decreased by the user's finger passing between a light emitting device of the second optical sensor and the light receiving device of the second optical sensor, and wherein the user's finger movement is sensed based on an interval between the time when the quantity of the light received by the light receiving device of the first optical sensor is decreased and the time when the quantity of the light received by the light receiving device of the second optical sensor is decreased.

10. A method for turning a page in a personal information terminal, the method comprising:
sensing a trace of a user's finger movement; and
turning the page in cooperation with an output device according to the sensing of a finger movement sensing unit.

11. A method for turning a page in a personal information terminal, the method comprising:
(a) sensing a trace of a user's finger movement;
(b) extracting a characteristic of the sensed trace;
(c) determining a suitability of the extracted characteristic for turning the page; and
(d) outputting a turned page to an output device, if the characteristic is suitable for turning the page, based on the determination performed in the step (c).

12. The method of claim 11, wherein the trace of the user's finger movement is sensed by a touch screen.

13. The method of claim 11, wherein the characteristic comprises at least one of a direction, a length, and a continuity of the trace.

14. The method of claim 11, further comprising outputting at least one of an animation and a sound indicating a page turning.

15. The method of claim 11, wherein the personal information terminal comprises one of a PDA and a laptop computer.

16. A method for turning a page in a personal information terminal, the method comprising:
sensing a touch of a user's finger by a first soft touch sensor and a second soft touch sensor; and
outputting a turned page to an output device if the first soft touch sensor and the second soft touch sensor sense the touch of the user's finger, respectively, in a predetermined interval.

17. A method for turning a page in a personal information terminal, the method comprising:
(a) sensing a user's finger movement by an optical sensor; and
(b) outputting a turned page to an output device if the optical sensor senses the user's finger movement.

18. The method of claim 17, wherein the optical sensor comprises a first optical sensor and a second optical sensor, and wherein, in the step of sensing of the user's finger movement:
a quantity of light received by a light receiving device of the first optical sensor is decreased by the user's finger passing between a light emitting device of the first optical sensor and the light receiving device of the first optical sensor;
a quantity of light received by a light receiving device of the second optical sensor is decreased by the user's finger passing between a light emitting device of the second optical sensor and the light receiving device of the second optical sensor; and
the user's finger movement is sensed based on at least an interval between the time when the quantity of the light received by the light receiving device of the first optical sensor is decreased and the time when the quantity of the light received by the light receiving device of the second optical sensor is decreased.
